(19) United States
(12) Patent Application Publication
(10) Pub. No.: US 2021/0105179 A1
(43) Pub. Date: Apr. 8, 2021

(54) Fault management method and related apparatus

(71) Applicant: HUAWEI TECHNOLOGIES CO., LTD., Shenzhen (CN)

(72) Inventors: Xiaoqian JIA, Shanghai (CN); Ruiyue XU, Shanghai (CN); Kai ZHANG, Shanghai (CN)

(21) Appl. No.: 17/127,268

(22) Filed: Dec. 18, 2020

Related U.S. Application Data
(63) Continuation of application No. PCT/CN2019/089774, filed on Jun. 3, 2019.

(30) Foreign Application Priority Data
Jun. 20, 2018 (CN) 201810639112.X

(51) Int. Cl. H04L 12/24

(52) U.S. Cl. CPC H04L 41/0677; H04L 41/0816; H04L 41/5025

(57) ABSTRACT

Embodiments of this application disclose a fault management method. In a slice network, if a first management unit determines fault information in the slice network, the first management unit may determine, based on the fault information and an association relationship between slices, potential fault information that may exist in the slice network. Because an association relationship between an NSI and an NSSI and an association relationship between an NSI and a service that are included in the slice network can reflect a network topology relationship between parts in the slice network, the potential fault information determined based on the association relationship can reflect impact of a fault on the slice network by using the network topology relationship. An embodiment of this application further discloses a related apparatus for fault management.

### CROSS-REFERENCE TO RELATED APPLICATIONS

This application is a continuation of International Application No. PCT/CN2019/089774, filed on Jun. 3, 2019, which claims priority to Chinese Patent Application No. 201810639112.X, filed on Jun. 20, 2018. The disclosures of the aforementioned applications are hereby incorporated by reference in their entireties.

### TECHNICAL FIELD

This application relates to the data processing field, and in particular, to fault management.

### BACKGROUND

With development of network services, a network may provide various service functions for a tenant. The service may be a group of communications services with a specified service level agreement (SLR) that a user can enjoy, for example, a mobile broadband (MBB) service, a voice service, an internet of things (TOT) service, an intelligent parking service, and an intelligent meter reading service.

A network slice (NSL) is an important technical means for a next-generation network to meet special service requirements of different industries and different tenants on a network. The network slice is a type of communication resource that can ensure that a bearer service can meet a service level agreement (SLR). Hard isolation (physical isolation) or soft isolation (logical isolation) may be performed on such resources based on different requirements. It may be considered that one network slice is a combination of network functions and resources required for completing one or more services, and the network slice is a complete logical network.

### SUMMARY

Embodiments of this application provide a fault management method and a related apparatus. Potential fault information is detected in advance, so that corresponding processing can be performed before an actual fault occurs in an NSI having a potential fault, an NSSI having a potential fault, and/or a service having a potential fault, to avoid interruption of a group call service caused by the actual fault, thereby improving service continuity provided by a slice network.

According to a first aspect, an embodiment of this application provides a fault management method, applied to a slice network. The method includes:

determining, by a first management unit, fault information, where the fault information includes a faulty slice and/or a faulty service, and the faulty slice includes a faulty network slice instance NSI and/or a faulty network slice subnet instance NSSI in the slice network; and

determining, by the first management unit, potential fault information in the slice network based on the fault information and an association relationship, where the potential fault information includes an NSI having a potential fault, an NSSI having a potential fault, and/or a service having a potential fault; and the association relationship includes an association relationship between an NSI and an NSSI and/or an association relationship between an NSI and a service in the slice network.

It can be learned from the foregoing technical solution that, in the slice network, if the first management unit determines the fault information in the slice network, for example, the faulty slice and/or the faulty service, the first management unit may determine, based on the fault information and an association relationship between slices, the potential fault information that may exist in the slice network, for example, the NSI, the NSSI, and/or the service that may have a potential fault. Because the association relationship between an NSI and an NSSI and the association relationship between an NSI and a service that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the service having a potential fault, to avoid interruption of a group call service caused by the actual fault, thereby improving service continuity provided by the slice network, and improving experience of a tenant in use of the slice network.

In one embodiment, the determining, by a first management unit, fault information includes:

receiving, by the first management unit, a first message sent by a second management unit, where the first message includes one or a combination of an identifier of the faulty NSI, an identifier of the NSI having a potential fault, an identifier of the faulty NSSI, an identifier of a faulty network function NF, or an identifier of the faulty service; and

determining, by the first management unit, the fault information based on the first message.

It can be learned that when the second management unit determines the fault in the slice network, the first management unit may directly determine the fault information by using the first message that is used to identify the fault and that is sent by the second management unit, thereby improving fault management efficiency.

In one embodiment, the determining, by a first management unit, fault information includes:

obtaining, by the first management unit, a second message sent by a second management unit, where the second message includes one or a combination of performance information of the NSSI, an NSSI identifier, an NF identifier, and a service identifier that are managed by the second management unit; and

determining, by the first management unit, the fault information based on the second message.

It can be learned that the first management unit may obtain, from the second management unit, the second message used to identify information such as the NSSI performance, and determine the fault information by analyzing the second message, thereby improving accuracy and comprehensiveness of fault determining.

In one embodiment, if the faulty slice includes the faulty NSI and the association relationship includes the association relationship between an NSI and a service, the determining, by the first management unit, potential fault information in the slice network based on the fault information and an association relationship includes:

determining, by the first management unit based on the identifier of the faulty NSI and the association relationship between an NSI and a service, the service having a potential fault in one or more services corresponding to the faulty NSI.

In one embodiment, if the first message includes the identifier of the NSI having a potential fault, the faulty slice includes the faulty NSI, and the association relationship includes the association relationship between an NSI and a service, the determining, by the first management unit, potential fault information in the slice network based on the fault information and an association relationship includes:

determining, by the first management unit based on the association relationship between an NSI and a service, the service having a potential fault in services corresponding to the identifier of the faulty NSI and the identifier of the NSI having a potential fault.

In one embodiment, if the faulty slice includes the faulty NSSI, and the association relationship includes the association relationship between an NSI and an NSSI and the association relationship between an NSI and a service, the determining, by the first management unit, potential fault information in the slice network based on the fault information and an association relationship includes:

determining, by the first management unit based on the identifier of the faulty NSSI and the association relationship between an NSI and an NSSI, the NSI having a potential fault in one or more NSIs corresponding to the faulty NSSI; and

determining, by the first management unit based on the identifier of the NSI having a potential fault and the association relationship between an NSI and a service, the service having a potential fault in one or more services corresponding to the NSI having a potential fault.

In one embodiment, if the association relationship includes the association relationship between an NSI and a service, the determining, by the first management unit, potential fault information in the slice network based on the fault information and an association relationship includes:

determining, by the first management unit based on the identifier of the faulty service and the association relationship between an NSI and a service, the NSI having a potential fault in one or more services corresponding to the faulty NSI.

In the foregoing embodiments, manners in which the first management unit determines the potential fault information by using the association relationship that can be invoked in different application scenarios are detailed.

In one embodiment, after the determining, by the first management unit, potential fault information in the slice network based on the fault information and an association relationship, the method further includes:

sending, by the first management unit, a warning message, where the warning message includes the potential fault information.

It can be learned that after determining the potential fault information, the first management unit may send the warning message to notify the slice network that a fault may soon occur, so that maintenance personnel can have time to perform remedy before the fault actually occurs, thereby improving stability and continuity of the slice network.

In one embodiment, after the determining, by the first management unit, potential fault information in the slice network based on the fault information and an association relationship, the method further includes:

performing, by the first management unit, fault processing based on the potential fault information, where

if the potential fault information includes the NSI having a potential fault and/or the NSSI having a potential fault, the fault processing includes reconfiguring the NSI having a potential fault and/or the NSSI having a potential fault; or if the potential fault information includes the service having a potential fault, the fault processing includes migrating the service having a potential fault to an NSI without a potential fault.

It can be learned that after determining the potential fault information, the first management unit may further directly process the potential fault information, to avoid an actual occurrence of the potential fault, thereby improving stability and continuity of the slice network.

According to a second aspect, an embodiment of this application provides a fault management apparatus, applied to a slice network. The apparatus includes a first determining unit and a second determining unit, where

the first determining unit is configured to determine fault information, where the fault information includes a faulty slice and/or a faulty service, and the faulty slice includes a faulty network slice instance NSI and/or a faulty network slice subnet instance NSSI in the slice network; and

the second determining unit is configured to determine potential fault information in the slice network based on the fault information and an association relationship, where the potential fault information includes an NSI having a potential fault, an NSSI having a potential fault, and/or a service having a potential fault; and the association relationship includes an association relationship between an NSI and an NSSI and/or an association relationship between an NSI and a service in the slice network.

It can be learned from the foregoing technical solution that, in the slice network, if the first determining unit determines the fault information in the slice network, for example, the faulty slice and/or the faulty service, the second determining unit may determine, based on the fault information and an association relationship between slices, the potential fault information that may exist in the slice network, for example, the NSI, the NSSI, and/or the service that may have a potential fault. Because the association relationship between an NSI and an NSSI and the association relationship between an NSI and a service that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the service having a potential fault, to avoid interruption of a group call service caused by the actual fault, thereby improving service continuity provided by the slice network, and improving experience of a tenant in use of the slice network.

In one embodiment, the first determining unit is further configured to receive a first message sent by a second management unit, where the first message includes one or a combination of an identifier of the faulty NSI, an identifier of the NSI having a potential fault, an identifier of the faulty NSSI, an identifier of a faulty network function NF, or an identifier of the faulty service; and

the first determining unit determines the fault information based on the first message.

It can be learned that when the second determining unit determines the fault in the slice network, the first determining unit may directly determine the fault information by using the first message that is used to identify the fault and that is sent by the second management unit, thereby improving fault management efficiency.

In one embodiment, the first determining unit is further configured to obtain a second message sent by a second management unit, where the second message includes one or a combination of performance information of the NSSI, an NSSI identifier, an NF identifier, and a service identifier that are managed by the second management unit; and

the first determining unit is further configured to determine the fault information based on the second message.

It can be learned that the first determining unit may obtain, from the second management unit, the second message used to identify information such as the NSSI performance, and determine the fault information by analyzing the second message, thereby improving accuracy and comprehensiveness of fault determining.

In one embodiment, if the faulty slice includes the faulty NSI and the association relationship includes the association relationship between an NSI and a service, the second determining unit is further configured to determine, based on the identifier of the faulty NSI and the association relationship between an NSI and a service, the service having a potential fault in one or more services corresponding to the faulty NSI.

In one embodiment, if the first message includes the identifier of the NSI having a potential fault, the faulty slice includes the faulty NSI, and the association relationship includes the association relationship between an NSI and a service, the second determining unit is further configured to determine, based on the association relationship between an NSI and a service, the service having a potential fault in services corresponding to the identifier of the faulty NSI and the identifier of the NSI having a potential fault.

In one embodiment, if the faulty slice includes the faulty NSSI, and the association relationship includes the association relationship between an NSI and an NSSI and an association relationship between an NSI and a service, the second determining unit is further configured to determine, based on the identifier of the faulty NSSI and the association relationship between an NSI and an NSSI, the NSI having a potential fault in one or more NSIs corresponding to the faulty NSSI; and

the second determining unit is further configured to determine, based on the identifier of the NSI having a potential fault and the association relationship between an NSI and a service, the service having a potential fault in one or more services corresponding to the NSI having a potential fault.

In one embodiment, the association relationship includes the association relationship between an NSI and a service, and the second determining unit is further configured to determine, based on the identifier of the faulty service and the association relationship between an NSI and a service, the NSI having a potential fault in one or more services corresponding to the faulty NSI.

In the foregoing embodiments, manners in which the second determining unit determines the potential fault information by using the association relationship that can be invoked in different application scenarios are detailed.

In one embodiment, the apparatus further includes a sending unit, where

the sending unit is configured to send a warning message, where the warning message includes the potential fault information.

It can be learned that after the first determining unit determines the potential fault information, the sending unit may send the warning message to notify the slice network that a fault may soon occur, so that maintenance personnel can have time to perform remedy before the fault actually occurs, thereby improving stability and continuity of the slice network.

In one embodiment, the apparatus further includes a processing unit, where

the processing unit is configured to perform fault processing based on the potential fault information, where

if the potential fault information includes the NSI having a potential fault and/or the NSSI having a potential fault, the fault processing includes reconfiguring the NSI having a potential fault and/or the NSSI having a potential fault; or if the potential fault information includes the service having a potential fault, the fault processing includes migrating the service having a potential fault to an NSI without a potential fault.

It can be learned that the second determining unit determines the potential fault information, the processing unit may further directly process the potential fault information, to avoid an actual occurrence of the potential fault, thereby improving stability and continuity of the slice network.

According to a third aspect, an embodiment of this application provides a fault management method, applied to a slice network. The method includes:

determining, by a first management unit, fault information, where the fault information includes a faulty network slice instance NSI, a faulty network slice subnet instance NSSI, and/or a faulty network function NF in the slice network; and

determining, by the first management unit, potential fault information in the slice network based on the fault information and an association relationship, where the potential fault information includes an NSI having a potential fault, an NSSI having a potential fault, and/or an NF having a potential fault; and the association relationship includes an association relationship between an NSI and an NSSI and/or an association relationship between an NSSI and an NF in the slice network.

It can be learned that, in the slice network, if the first fault management unit determines the fault information in the slice network, the first fault management unit may determine, based on the fault information and an association relationship between slices, the potential fault information that may exist in the slice network, for example, the NSI, the NSSI, and/or the NF that may have a potential fault. Because the association relationship between an NSI and an NSSI and the association relationship between an NSSI and an NF that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the NF having a potential fault, to avoid interruption of a group call service caused by the actual fault, thereby improving service continuity provided by the slice network, and improving experience of a tenant in use of the slice network.

In one embodiment, the determining, by a first management unit, fault information includes:

obtaining, by the first management unit, an identifier of the faulty NF sent by a network unit; and

determining, by the first management unit, the corresponding faulty NF based on the identifier of the faulty NF.

It can be learned that when the network unit determines the faulty NF in the slice network, the first management unit may directly determine the fault information by using the identifier of the faulty NF sent by the network unit, thereby improving fault management efficiency.

In one embodiment, the determining, by a first management unit, fault information includes:

obtaining, by the first management unit, service performance information sent by a network unit, where the service performance information is used to reflect NF performance; and

identifying, by the first management unit, the faulty NSSI and/or the faulty NF based on the service performance information.

It can be learned that the first management unit may obtain, from the network unit, the service performance information used to identify information such as NF performance, and determine the fault information by analyzing the service performance information, thereby improving accuracy and comprehensiveness of fault determining.

In one embodiment, the determining, by a first management unit, fault information includes:

obtaining, by the first management unit, an identifier of the faulty NSI sent by a second management unit; and

determining, by the first management unit, the corresponding faulty NSI based on the identifier of the faulty NSI.

It can be learned that when the second management unit determines the faulty NSI in the slice network, the first management unit may directly determine the fault information by using the identifier of the faulty NSI sent by the second management unit, thereby improving fault management efficiency.

In one embodiment, if the fault information includes the faulty NSI and the association relationship includes the association relationship between an NSI and an NSSI, the determining, by the first management unit, potential fault information in the slice network based on the fault information and an association relationship includes:

determining, by the first management unit based on the identifier of the faulty NSI and the association relationship between an NSI and an NSSI, the NSSI having a potential fault in one or more NSSIs corresponding to the faulty NSI.

In one embodiment, if the fault information includes the faulty NSSI and the association relationship includes the association relationship between an NSI and an NSSI, the determining, by the first management unit, potential fault information in the slice network based on the fault information and an association relationship includes:

determining, by the first management unit based on the identifier of the faulty NSSI and the association relationship between an NSI and an NSSI, the NSI having a potential fault in one or more NSIs corresponding to the faulty NSSI.

In one embodiment, if the fault information includes the faulty NSSI and the association relationship includes the association relationship between an NSSI and an NF, the determining, by the first management unit, potential fault information in the slice network based on the fault information and an association relationship includes:

determining, by the first management unit based on the identifier of the faulty NSSI and the association relationship between an NSSI and an NF, the NF having a potential fault in one or more NFs corresponding to the faulty NSSI.

In the foregoing three embodiments, manners in which the first management unit determines the potential fault information by using the association relationship that can be invoked in different application scenarios are detailed.

According to a fourth aspect, an embodiment of this application provides a fault management apparatus, applied to a slice network. The apparatus includes a first determining unit and a second determining unit, where

the first determining unit is configured to determine fault information, where the fault information includes a faulty network slice instance NSI, a faulty network slice subnet instance NSSI, and/or a faulty network function NF in the slice network; and

the second determining unit is configured to determine potential fault information in the slice network based on the fault information and an association relationship, where the potential fault information includes an NSI having a potential fault, an NSSI having a potential fault, and/or an NF having a potential fault; and the association relationship includes an association relationship between an NSI and an NSSI and/or an association relationship between an NSSI and an NF in the slice network.

It can be learned that, in the slice network, if the fault management apparatus determines the fault information in the slice network, the fault management apparatus may determine, based on the fault information and an association relationship between slices, the potential fault information that may exist in the slice network, for example, the NSI, the NSSI, and/or the NF that may have a potential fault. Because the association relationship between an NSI and an NSSI and the association relationship between an NSSI and an NF that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the NF having a potential fault, to avoid interruption of a group call service caused by the actual fault, thereby improving service continuity provided by the slice network, and improving experience of a tenant in use of the slice network.

In one embodiment, the first determining unit is further configured to obtain an identifier of the faulty NF sent by a network unit, and

the first determining unit is further configured to determine the corresponding faulty NF based on the identifier of the faulty NF.

It can be learned that when the network unit determines the faulty NF in the slice network, the first determining unit may directly determine the fault information by using the identifier of the faulty NF sent by the network unit, thereby improving fault management efficiency.

In one embodiment, the first determining unit is further configured to obtain service performance information sent by a network unit, where the service performance information is used to reflect NF performance; and

the first determining unit is further configured to identify the faulty NSSI and/or the faulty NF based on the service performance information.

It can be learned that the first determining unit may obtain, from the network unit, the service performance information used to identify information such as NF performance, and determine the fault information by analyzing the service performance information, thereby improving accuracy and comprehensiveness of fault determining.

In one embodiment, the first determining unit is further configured to obtain an identifier of the faulty NSI sent by a second management unit, and

the first determining unit is further configured to determine the corresponding faulty NSI based on the identifier of the faulty NSI.

It can be learned that when the second management unit determines the faulty NSI in the slice network, the first determining unit may directly determine the fault information by using the identifier of the faulty NSI sent by the second management unit, thereby improving fault management efficiency.

In one embodiment, if the fault information includes the faulty NSI and the association relationship includes the association relationship between an NSI and an NSSI, the second determining unit is further configured to determine, based on the identifier of the faulty NSI and the association relationship between an NSI and an NSSI, the NSSI having a potential fault in one or more NSSIs corresponding to the faulty NSI.

In one embodiment, if the fault information includes the faulty NSSI and the association relationship includes the association relationship between an NSI and an NSSI, the second determining unit is further configured to determine, based on the identifier of the faulty NSSI and the association relationship between an NSI and an NSSI, the NSI having a potential fault in one or more NSIs corresponding to the faulty NSSI.

In one embodiment, if the fault information includes the faulty NSSI and the association relationship includes the association relationship between an NSSI and an NF, the second determining unit is further configured to determine, based on the identifier of the faulty NSSI and the association relationship between an NSSI and an NF, the NF having a potential fault in one or more NFs corresponding to the faulty NSSI.

In the foregoing three embodiments, manners in which the second determining unit determines the potential fault information by using the association relationship that can be invoked in different application scenarios are detailed.

### BRIEF DESCRIPTION OF DRAWINGS

FIG. 1 is a schematic diagram of a network topology in a slice network according to an embodiment of this application;

FIG. 2 is a method flowchart of a fault management method according to an embodiment of this application;

FIG. 3 is a method flowchart of a fault management method according to an embodiment of this application;

FIG. 4 is a signaling flowchart of a fault management method according to an embodiment of this application;

FIG. 5 is a signaling flowchart of a fault management method according to an embodiment of this application;

FIG. 6 is a signaling flowchart of a fault management method according to an embodiment of this application;

FIG. 7 is a signaling flowchart of a fault management method according to an embodiment of this application;

FIG. 8 is an apparatus structural diagram of a fault management apparatus according to an embodiment of this application; and

FIG. 9 is an apparatus structural diagram of a fault management apparatus according to an embodiment of this application.

### DESCRIPTION OF EMBODIMENTS

The following describes the embodiments of this application with reference to the accompanying drawings.

With development of network services, a network may provide various service functions for a tenant. The tenant in the embodiments of this application may be understood as a renter of an operator network. For example, if an electric power company rents an operator network to deploy an intelligent meter reading service, the electric power company may be a renter of an operator. The tenant generally has a high requirement on a network and often has a personalized customization requirement. Therefore, requirements on various network indicators of the network in which the tenant is located need to be ensured.

During network operation, faults are inevitable. If an alarm process is triggered after a fault is detected in functional modules that provide the personalized customization requirement for the tenant, a tenant service cannot be effectively ensured and a preset indicator requirement cannot be met. Therefore, to ensure continuity of the tenant service, an effective fault detection mechanism needs to be introduced into a slice network, to detect, in advance, a network slice that may fail.

Therefore, an embodiment of this application provides a fault management method, to detect, in advance, a network element having a potential fault and/or a service having a potential fault in a slice network, so that processing can be performed before the network element having a potential fault and/or the service having a potential fault actually fail/fails, to avoid interruption of a tenant service caused by the fault that actually occurs.

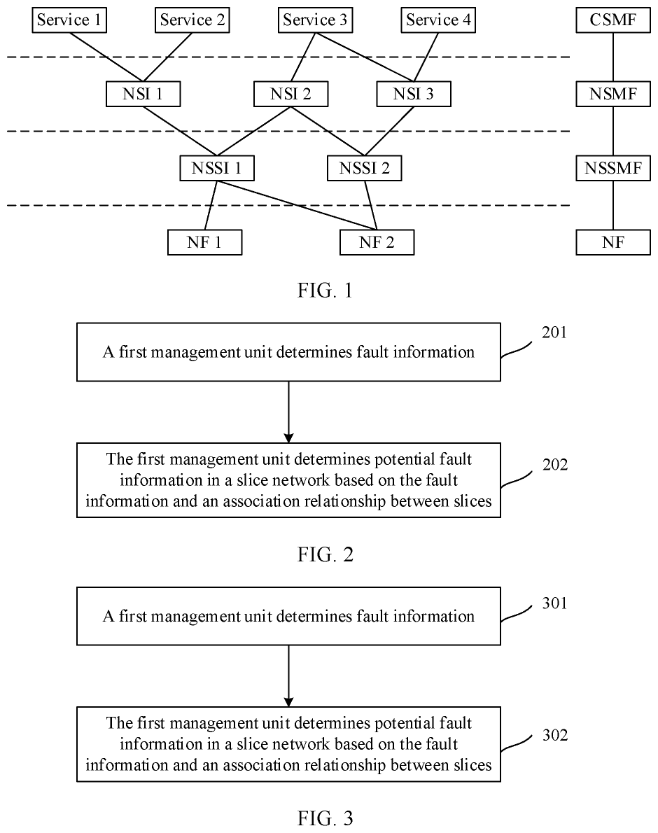

In this embodiment of this application, the fault management method may be applied to a slice network. The slice network may include a plurality of network slice instances (NSI), services carried in the network slices, and network functions (NF) implemented by the network slices. The NSI is a component of the slice network, and one NSI may include at least one network slice subnet instance (NSSI). The NSSI may also be a component of the slice network, one NSI includes at least one NSSI, and one NSSI may include at least one network slice. For example, as shown in FIG. 1, an NSI 2 may include an NSSI 1 and an NSSI 2.

To carry various services and implement various functions, a specific network topology relationship between a service, an NSI, an NSSI, and an NF needs to be set in the slice network. Based on the network topology relationship, a specific NSI that carries a specific service or specific NSIs that carry specific services may be determined, and a specific NSI and/or a specific NSSI that is used for implementing a function or specific NSIs and/or specific NSSIs that are used for implementing functions may be determined. For example, a connection line shown in FIG. 1 may reflect a network topology relationship in a slice network. The network topology relationship may reflect not only a mutual composition relationship between network elements in the slice network, but also a bearer relationship between a service and a network slice in the slice network, an implementation relationship between functions, and the like. For example, a service 1 and a service 2 are carried by an NSI 1 and an NSSI 1, and an NF 1 of the service 1 and an NF 2 of the service 2 may be implemented by using the NSI 1 and the NSSI 1. The network topology relationship of the slice network may be reflected by using an association relationship. For example, there is an association relationship between two connected components shown in FIG. 1. For example, the service 1 and the service 2 are associated with the NSI 1, and the NSI 1 and the NSI 2 are associated with the NSSI 1.

In the slice network, for ease of management, a management architecture of the slice network is a hierarchical management architecture. In other words, the slice network may be divided into a plurality of layers, and each layer has a corresponding management unit for management. For example, the slice network may be divided into a service layer, an NSI layer, and an NF layer. In some slice networks, in addition to the foregoing layers, an NSSI layer may further be obtained through division.

The service that needs to be carried by the slice network is included at the service layer, and the service at the layer may be managed by a communication service management function (CSMF). The NSI is included at the NSI layer, and the NSSI in the slice network is included at the NSSI layer. The two layers may be respectively managed by different types of slice management units. For example, for the NSI layer, the NSI at the layer may be managed by a network slice management function (NSMF), and for the NSSI layer, the NSSI at the layer may be managed by a network slice subnet management function (NSSMF). The NF that can be implemented in the slice network is included at the NF layer. The hierarchical management architecture of the slice network may be shown in FIG. 1. The CSMF is configured to manage a service 1 to a service 4 at the service layer, the NSMF is configured to manage an NSI 1 to an NSI 3 at the network slice layer, and the NSSMF is configured to manage an NSSI 1 and an NSSI 2 at the subnet slice layer.

After the hierarchical management architecture of the slice network, the association relationship that reflects the network topology relationship, and a function of each layer are clarified, the following describes, with reference to the accompanying drawings, a fault management method provided in an embodiment of this application. FIG. 2 is a method flowchart of a fault management method according to an embodiment of this application.

201: A first management unit determines fault information.

The fault information may be a faulty service and/or a faulty slice in a slice network. There may be one or more faulty slices or faulty services. For example, the faulty slice may be an NSI and/or an NSSI that has failed, and the faulty slices may be some NSIs and/or some NSSIs that have failed. After determining the fault information, the first management unit may find potential fault information corresponding to the fault information based on an association relationship that can be invoked.

The first management unit may determine the fault information based on a message sent by a second management unit. A specific form of the message sent by the second management unit and how the corresponding first management unit determines the fault information are described below in detail.

In one embodiment, the first management unit in this application may be specifically an NSMF in the slice network, and the second management unit in this application may be specifically an NSSMF in the slice network. For ease of description, in the following embodiments, an example in which the NSMF is used as the first management unit and the NSSMF is used as the second management unit is used for description.

Therefore, for operation 201, the NSMF may determine the fault information based on the message reported by the NSSMF. This embodiment of this application provides two optional reporting manners.

In the first reporting manner, the NSMF may obtain a first message from the NSSMF. The first message includes one or a combination of an identifier of a faulty NSI, an identifier of an NSI having a potential fault, an identifier of a faulty NSSI, an identifier of a faulty NF, or an identifier of a faulty service. In other words, the NSSMF may directly report, to the NSMF, the fault information found by the NSSMF, for example, the identifiers of the faulty NSI, the faulty NSSI, and the faulty NF, so that the NSMF can directly determine, based on the identifier carried in the first message, a fault in the slice network, for example, an NSI corresponding to the identifier of the faulty NSI, or an NSSI corresponding to the identifier of the faulty NSSI.

In this manner, because the NSMF has determined the fault in the slice network, system resources of the NSMF can be saved, and efficiency of determining the potential fault information can be improved.

In the second reporting manner, the NSMF may alternatively obtain a second message reported by the NSSMF. The second message may include one or a combination of performance information of the NSSI, an NSSI identifier, an NF identifier, and a service identifier that are managed by the second management unit (for example, the NSSMF). In other words, in this manner, when the NSSMF does not need to determine the fault in the slice network, or when the NSSMF cannot determine the fault in the slice network, the NSMF may determine the fault information.

The NSMF may process the performance information of the NSSI in the second message to identify the faulty NSSI. Alternatively, the NSMF may aggregate a plurality of received second messages, for example, a plurality of second messages obtained in a time period, and then determine the faulty NSI based on a comparison between or a variation trend of related performance information of NSSIs in the second messages. Alternatively, the NSMF may determine the faulty service based on identifiers and the like that are carried in the second message.

In this manner, the NSMF may determine, by aggregating the obtained second messages, the fault information that may not be determined by the NSSMF, thereby improving accuracy of subsequently determining the potential fault information.

The NSMF may alternatively determine the fault information in both the foregoing two manners. In other words, the NSMF may obtain both the first message and the second message from the NSSMF. When determining the fault information, the NSMF may determine the fault information based on a faulty network element determined by using the second message and with reference to the identifier that is of the fault and that is carried in the first message. In this way, accuracy of determining the fault information is improved.

In the foregoing two manners, the fault information determined by the NSMF may include the faulty NSI, the faulty NSSI, and/or the faulty service. Then, the NSMF may determine the potential fault information based on the fault information and an association relationship that can be invoked by the NSMF.

202: The first management unit determines the potential fault information in the slice network based on the fault information and an association relationship between slices.

The association relationship may be stored in a local storage location of the first management unit, or may be stored in another storage location that can be invoked by the first management unit. The association relationship includes an association relationship between an NSI and an NSSI and/or an association relationship between an NSI and a service in the slice network. The association relationship may be used for identifying all or some network topology relationships in the slice network. A specific quantity of network topology relationships included in the slice network may be determined based on a specific application scenario, or may be determined based on layers managed by the first management unit. Specific content of the association relationship is not described in detail herein, and details are described in the following embodiments.

Because the association relationship can reflect a network topology relationship in the slice network, an NSI, an NSSI, or a service that has an association relationship with the faulty service and/or the faulty slice in the slice network may be determined based on the identifier of the faulty service and/or the identifier of the faulty slice in the fault information and the association relationship. Because the determined NSI, NSSI, service, and the like have an association relationship with the faulty service and/or the faulty slice, the faulty service and/or the faulty slice may directly or indirectly affect normal use of the NSI, the NSSI, and the service. For example, the faulty slice may be a component of the determined NSI, or all or some of the determined services may need to be carried by the faulty slice.

Based on this, the first management unit may determine the possible potential fault information in the slice network based on the NSI, the NSSI, the service, and the like that are determined based on the fault information and the association relationship. The potential fault information may include an NSI having a potential fault, an NSSI having a potential fault, and/or a service having a potential fault.

It can be learned that, in the slice network, if the first management unit determines the fault information in the slice network, for example, the faulty slice and/or the faulty service, the first management unit may determine, based on the fault information and an association relationship between slices, the potential fault information that may exist in the slice network, for example, the NSI, the NSSI, and/or the service that may have a potential fault. Because the association relationship between an NSI and an NSSI and the association relationship between an NSI and a service that are included in the slice network can reflect the network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the service having a potential fault, to avoid interruption of a group call service caused by the actual fault, thereby improving service continuity provided by the slice network, and improving experience of a tenant in use of the slice network.

Then, the fault detection method provided in this embodiment of this application is further described based on a possible type of the first management unit and with reference to different application scenarios.

In one embodiment, the first management unit in this application may be specifically an NSMF in the slice network. For different application scenarios, the NSMF has different fault detection mechanisms. This embodiment of this application is mainly described with reference to three application scenarios. In different application scenarios, specific content of an association relationship that can be invoked by the NSMF is different.

In the first application scenario, an association relationship that can be invoked by the NSMF when the NSMF detects the potential fault information includes the association relationship between an NSI and a service. For example, in the slice network shown in FIG. 1, the association relationship between an NSI and a service may include an association relationship between the service 1 or the service 2 and the NSI 1, and an association relationship between the service 3 and the NSI 2 or the NSI 3.

Because the NSI is used for carrying a service, if an NSI fails, the service carried by the NSI is likely to fail because of the faulty NSI even if no fault is currently detected in the service.

In the second application scenario, an association relationship that can be invoked by the NSMF when the NSMF detects the potential fault information includes the association relationship between an NSI and an NSSI. For example, in the slice network shown in FIG. 1, the association relationship between an NSI and an NSSI may include an association relationship between the NSI 1 or the NSI 2 and the NSSI 1, and an association relationship between the NSI 2 or the NSI 3 and the NSSI 2.

For the association relationship between an NSI and an NSSI, because the NSI may include NSSIs, if one of the NSSIs included in the NSI fails, the NSI is likely to fail because of the faulty NSSI even if no fault is currently detected in the NSI.

In the third application scenario, an association relationship that can be invoked by the NSMF when the NSMF detects the potential fault information includes the association relationship between an NSI and an NSSI and the association relationship between an NSI and a service. For example, in the slice network shown in FIG. 1, the association relationship between an NSI and an NSSI may include an association relationship between the NSI 1 or the NSI 2 and the NSSI 1, and an association relationship between the NSI 2 or the NSI 3 and the NSSI 2; and the association relationship between an NSI and a service may include an association relationship between the service 1 or the service 2 and the NSI 1, and an association relationship between the service 3 and the NSI 2 or the NSI 3.

If a faulty NSSI is determined, an NSI that has an association relationship with the NSSI is likely to fail because of the faulty NSSI even if no fault is currently detected in the NSI. If a faulty NSI is determined, a service carried by the NSI is likely to fail because of the faulty NSI even if no fault is currently detected in the service.

After the content that may be included in the association relationship that can be invoked by the NSMF in different application scenarios is described, fault detection mechanisms of the NSMF in different application scenarios are described below.

First, a fault detection mechanism of the NSMF in the first application scenario is described. In the first application scenario, an association relationship that can be invoked when the potential fault information is detected includes the association relationship between an NSI and a service.

In one embodiment, the fault information determined by the NSMF in operation 201 includes a faulty NSI and a faulty NSSI, or includes only a faulty NSI. Because the NSMF can invoke the association relationship between an NSI and a service, in operation 202, for the faulty NSI, the NSMF may search for the association relationship between an NSI and a service based on an identifier of the faulty NSI, and determine a service having a potential fault in one or more services corresponding to the identifier of the faulty NSI, where the determined service having a potential fault may be used as the potential fault information.

When the faulty service is determined, all services corresponding to the identifier of the faulty NSI may be determined as services having a potential fault, or some services corresponding to the identifier of the faulty NSI may be determined as services having a potential fault. A specific determining manner is not limited in this embodiment of this application. For example, in the slice network shown in FIG. 1, if the NSMF determines that the NSI 1 is a faulty NSI, the NSMF searches for the association relationship between an NSI and a service based on an identifier of the NSI 1, and learns that services corresponding to the identifier of the NSI 1 are the service 1 and the service 2. The NSMF may determine both the service 1 and the service 2 as the services having a potential fault, or may determine one of the service 1 and the service 2 as the service having a potential fault.

In one embodiment, in the foregoing first reporting manner, the first message reported by the NSSMF may further include an identifier of the NSI having a potential fault that is detected by the NSSMF. Therefore, in operation 202, the NSMF may further search for an association relationship based on the identifier of the faulty NSI and the identifier of the NSI having a potential fault, and determine the service having a potential fault in one or more services corresponding to the identifier of the faulty NSI and the identifier of the NSI having a potential fault.

In one embodiment, in the foregoing first reporting manner, the first message reported by the NSSMF may further include an identifier of the faulty service. In other words, the NSMF may further include the faulty service in the fault information determined in operation 201. In operation 202, the NSMF may further search for an association relationship based on the faulty service, and determine the NSI having a potential fault in one or more NSIs corresponding to the faulty service. Further, the NSMF may further determine, based on the determined NSI having a potential fault and the association relationship, the service having a potential fault that corresponds to the NSI having a potential fault.

The NSI having a potential fault and/or the service having a potential fault that are/is determined by the NSMF in operation 202 may be used as the potential fault information.

Then a fault detection mechanism of the NSMF in the second application scenario is described. In the second application scenario, an association relationship that can be invoked when the potential fault information is detected includes the association relationship between an NSI and an NSSI.

If the fault information determined by the NSMF in operation 201 includes a faulty NSSI, because the NSMF can invoke the association relationship between an NSI and an NSSI, in operation 202, for the faulty NSSI in the fault information, the NSMF may search for the association relationship between an NSI and an NSSI based on an identifier of the faulty NSSI, and determine an NSI having a potential fault in one or more NSIs corresponding to the identifier of the faulty NSSI.

In one embodiment, if the fault information determined by the NSMF in operation 201 includes a faulty NSI, in operation 202, the NSMF may further search for the association relationship between an NSI and an NSSI based on the identifier of the faulty NSI, and determine an NSSI having a potential fault in one or more NSSIs corresponding to the identifier of the faulty NSI.

The NSI having a potential fault and/or the NSSI having a potential fault that are/is determined by the NSMF in operation 202 may be used as the potential fault information.

Then a fault detection mechanism of the NSMF in the third application scenario is described. In the third application scenario, an association relationship that can be invoked when the potential fault information is detected includes the association relationship between an NSI and an NSSI and the association relationship between an NSI and a service.

If the fault information determined by the NSMF in operation 201 includes a faulty NSSI, because the NSMF can invoke the association relationship between an NSI and an NSSI and the association relationship between an NSI and a service, in operation 202, for the faulty NSSI in the fault information, the NSMF may search for the association relationship between an NSI and an NSSI based on an identifier of the faulty NSSI, and determine an NSI having a potential fault in one or more NSIs corresponding to the identifier of the faulty NSSI. Then the NSMF may further search for the association relationship between an NSI and a service based on an identifier of the NSI having a potential fault, and determine a service having a potential fault in one or more services corresponding to the identifier of the NSI having a potential fault.

In one embodiment, if the fault information determined by the NSMF in operation 201 includes a faulty NSI, in operation 202, the NSMF may further search for the association relationship between an NSI and a service based on an identifier of the faulty NSI, and determine a service having a potential fault in one or more services corresponding to the identifier of the faulty NSI. The NSMF may further search for the association relationship between an NSI and an NSSI based on the identifier of the faulty NSI, and determine an NSSI having a potential fault in one or more NSSIs corresponding to the identifier of the faulty NSI.

In one embodiment, if the fault information determined by the NSMF in operation 201 includes a faulty service, in operation 202, the NSMF may further search for the association relationship between an NSI and a service based on an identifier of the faulty service, and determine an NSI having a potential fault in one or more NSIs corresponding to the identifier of the faulty service. The NSMF may further search for the association relationship between an NSI and an NSSI based on an identifier of the NSI having a potential fault, and determine an NSSI having a potential fault in one or more NSSIs corresponding to the identifier of the NSI having a potential fault.

According to the descriptions of the fault detection mechanisms of the NSMF in the foregoing three application scenarios, the NSMF determines the potential fault information by searching for the association relationship between an NSI and an NSSI and/or the association relationship between an NSI and a service, so that a possibility that the NSMF can detect a potential fault in advance can be increased.

The first management unit needs to perform processing based on the determined potential fault information, to avoid impact, on service continuity provided by the slice network, caused by an actual fault in the NSI having a potential fault, the NSSI having a potential fault, and/or the service having a potential fault.

Therefore, after the fault detection mechanisms in different scenarios in which the NSMF is used as the first management unit are described, the following describes how the first management unit processes the determined potential fault information.

After the first management unit determines the potential fault information, that is, after operation 202, the first management unit may further process the potential fault information to avoid a potential fault. Two optional processing manners are described in this embodiment of this application.

In the first processing manner, the first management unit sends a warning message, where the warning message includes the potential fault information.

In this processing manner, the first management unit may notify another processing device of a potential fault in the slice network by using the warning message, so that the another processing device processes the potential fault in the slice network. A receiver of the warning message may be a CSMF.

In one embodiment, the warning message may further include the fault information determined by the first management unit in operation 201, so that a receiver, such as the CSMF, that receives the warning message may learn of the potential fault in the slice network by using the warning message, and also learn of a fault that has occurred in the slice network, to facilitate subsequent unified processing. In the second processing manner, the first management unit performs fault processing based on the potential fault information.

If the potential fault information includes the NSI having a potential fault and/or the NSSI having a potential fault, the fault processing includes reconfiguring the NSI having a potential fault and/or the NSSI having a potential fault; or if the potential fault information includes the service having a potential fault, the fault processing includes migrating the service having a potential fault to an NSI and/or an NSSI without a potential fault.

Through reconfiguration of the NSI and/or the NSSI, interruption of a service originally configured on the NSI and/or the NSSI caused by a fault that occurs in the NSI having a potential fault and/or the NSSI having a potential fault may be avoided.

A main cause of the potential fault in the service is the faulty NSI and/or the faulty NSSI. Therefore, the service having a potential fault may be migrated to the NSI and/or the NSSI without a potential fault, and the service is carried by the NSI and/or the NSSI without a potential fault, to avoid service interruption caused by a sudden fault in the NSI having a potential fault and/or the NSSI having a potential fault.

In the slice network, the NSMF may determine the fault information and determine the potential fault information in the slice network based on the fault information and the association relationship that can be invoked. In addition, the NSSMF may also determine the fault information and the potential fault information. When the NSSMF is used as the first management unit, the following mainly describes, with reference to the accompanying drawings, an implementation of how the NSSMF determines the fault information and determines the potential fault information in the slice network based on the fault information and the association relationship that can be invoked. It should be noted that, in some implementations, definitions of the fault information and the potential fault information in this embodiment may be different from definitions of the fault information and the potential fault information in an embodiment in which the first management unit is described. In addition, in this embodiment, the first management unit is also different from the first management unit in the foregoing embodiment, and the second management unit is also different from the second management unit in the foregoing embodiment.

As shown in FIG. 3, the fault management method includes the following operations.

301. A first management unit determines fault information.

The fault information includes a faulty NSI, a faulty NSSI, and/or a faulty NF in a slice network.

The first management unit may determine the fault information based on a message sent by a second management unit or a network unit. A specific form of the message sent by the network unit and how the corresponding first management unit determines the fault information are described below in detail.

In one embodiment, the first management unit in this application may be specifically an NSSMF in the slice network, and the network unit in this application may be specifically an NF in the slice network. For ease of description, in the following embodiments, an example in which the NSSMF is used as the first management unit and the NF is used as the network unit is used for description.

Therefore, for operation 301, the NSSMF may determine the fault information based on the message reported by the NF. This embodiment of this application provides at least three optional reporting manners.

In the first reporting manner, the NSSMF may obtain an identifier of the faulty NF from the NF. In other words, the NF may directly report, to the NSSMF, the fault information found by the NF, for example, the identifier of the faulty NF, so that the NSMF can directly determine, based on the identifier of the faulty NF, the faulty NF in the slice network.

In this manner, because the NF has determined the faulty NF in the slice network, system resources of the NSSMF can be saved, and efficiency of determining the potential fault information can be improved.

In the second reporting manner, the NSSMF may alternatively obtain reported service performance information from the NF, and the service performance information may be used to reflect NF performance. In other words, in this manner, when the NF does not need to determine the faulty NF and/or the faulty NSSI in the slice network, or when the NF cannot determine the faulty NF and/or the faulty NSSI in the slice network, the NSSMF may determine the fault information. The first management unit identifies the faulty NF and/or the faulty NSSI based on the obtained service performance information, or the NSSMF may further aggregate a plurality of pieces of received service performance information, for example, a plurality of pieces of service performance information obtained in a time period, then determine the faulty NF and/or the faulty NSSI based on comparison between or a variation trend of NF performance in each piece of service performance information.

In this manner, the NSMF may determine, by aggregating the obtained service performance information, the faulty NF and/or the faulty NSSI that may not be determined by the NF, thereby improving accuracy of subsequently determining the potential fault information.

Alternatively, the NSSMF may determine the fault information in both the foregoing two manners. In other words, the NSSMF may obtain both the identifier of the faulty NF from the NF and the service performance information from the NF. When determining the fault information, the NSSMF may determine the faulty NF and/or the faulty NSSI based on the service performance information, and determine and verify the faulty NF with reference to the identifier of the faulty NF. In this way, accuracy of determining the fault information is improved.

In the third reporting manner, the NSSMF used as the first management unit may further obtain an identifier of the faulty NSI sent by the second management unit. In one embodiment, the second management unit may be an NSMF. In other words, because the NSMF is responsible for managing the NSI at the NSI layer in the slice network, when detecting the faulty NSI, the NSMF may notify the NSSMF of the identifier of the faulty NSI, so that the NSSMF can directly determine the corresponding faulty NSI based on the identifier of the faulty NSI, system resources of the NSSMF are saved, and efficiency of determining potential fault information is improved.

In the foregoing three manners, the fault information determined by the NSSMF may include the faulty NSSI and/or the faulty service. Then, the NSSMF may determine the potential fault information based on the fault information and an association relationship that can be invoked by the NSSMF.

302. The first management unit determines the potential fault information in the slice network based on the fault information and an association relationship.

The association relationship may be stored in a local storage location of the first management unit, or may be stored in another storage location that can be invoked by the first management unit. The association relationship includes an association relationship between an NSI and an NSSI and/or an association relationship between an NSSI and an NF in the slice network. The association relationship may be used for identifying all or some network topology relationships in the slice network. A specific quantity of network topology relationships included in the slice network may be determined based on a specific application scenario, or may be determined based on layers managed by the first management unit. Specific content of the association relationship is not described in detail herein, and details are described in the following embodiments.

Because the association relationship can reflect the network topology relationship in the slice network, an NSI or an NSSI that has an association relationship with the faulty NSSI and/or the faulty NF in the slice network may be determined based on an identifier of the faulty NSSI and/or the identifier of the faulty NF in the fault information and the association relationship. Because the determined NSI, NSSI, and the like have an association relationship with the faulty NSSI and/or the faulty NF, the faulty NSSI and/or the faulty NF directly or indirectly affect normal use of the NSI and the NSSI.

Based on this, the first management unit may determine the possible potential fault information in the slice network based on the NSI, the NSSI, and the like that are determined based on the fault information and the association relationship. The potential fault information may include an NSI having a potential fault and/or an NSSI having a potential fault.

It can be learned that, in the slice network, if the first management unit determines the fault information in the slice network, the first management unit may determine, based on the fault information and an association relationship between slices, the potential fault information that may exist in the slice network, for example, the NSI, the NSSI, and/or the NF that may have a potential fault. Because the association relationship between an NSI and an NSSI and the association relationship between an NSSI and an NF that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the NF having a potential fault, to avoid interruption of a group call service caused by the actual fault, thereby improving service continuity provided by the slice network, and improving experience of a tenant in use of the slice network.

Then, the fault detection method provided in this embodiment of this application is further described based on a possible type of the first management unit and with reference to different application scenarios.

In one embodiment, the first management unit in this application may be specifically an NSSMF in the slice network. For different application scenarios, the NSSMF has different fault detection mechanisms. This embodiment of this application is mainly described with reference to three application scenarios. In different application scenarios, specific content of an association relationship that can be invoked by the NSSMF is different.

In the first application scenario, an association relationship that can be invoked by the NSSMF when the NSSMF detects the potential fault information includes the association relationship between an NSI and an NSSI. For example, in the slice network shown in FIG. 1, the association relationship between an NSI and an NSSI may include an association relationship between the NSI 1 or the NSI 2 and the NSSI 1, and an association relationship between the NSI 2 or the NSI 3 and the NSSI 2.

Because the NSI is used for carrying a service, if an NSI fails, the service carried by the NSI is likely to fail because of the faulty NSI even if no fault is currently detected in the service.

In the second application scenario, an association relationship that can be invoked by the NSSMF when the NSSMF detects the potential fault information includes the association relationship between an NSSI and an NF. For example, in the slice network shown in FIG. 1, the association relationship between an NSSI and an NF may include an association relationship between the NSSI 1 and the NF 1 or the NF 2, and an association relationship between the NSSI 2 and the NF 2.

For the association relationship between an NSSI and an NF, because the NF may be implemented through the NSSI, if the NF fails, the NSSI implementing the NF is bound to fail.

In the third application scenario, an association relationship that can be invoked by the NSSMF when the NSSMF detects the potential fault information includes the association relationship between an NSI and an NSSI and the association relationship between an NSSI and an NF.

If a faulty NSSI is determined, an NSI that has an association relationship with the NSSI is likely to fail because of the faulty NSSI even if no fault is currently detected in the NSI. If a faulty NF is determined, an NSSI implementing the NF is bound to fail.

After the content that may be included in the association relationship that can be invoked by the NSSMF in different application scenarios is described, fault detection mechanisms of the NSSMF in different application scenarios are described below.

First, a fault detection mechanism of the NSSMF in the first application scenario is described. In the first application scenario, an association relationship that can be invoked when the potential fault information is detected includes the association relationship between an NSI and an NSSI.

In one embodiment, the fault information determined by the NSSMF in operation 301 includes a faulty NSSI. Because the NSSMF can invoke the association relationship between an NSI and an NSSI, in operation 302, for the faulty NSSI, the NSSMF may search for the association relationship between an NSI and an NSSI based on an identifier of the faulty NSSI, and determine an NSI having a potential fault in one or more NSIs corresponding to the identifier of the faulty NSSI, where the determined NSI having a potential fault may be used as the potential fault information.

When the faulty NSI is determined, all NSIs corresponding to the identifier of the faulty NSSI may be determined as NSIs having a potential fault, or some NSIs corresponding to the identifier of the faulty NSSI may be determined as NSIs having a potential fault. A specific determining manner is not limited in this embodiment of this application.

In one embodiment, the NSSMF may further determine, based on the identifier of the NSI having a potential fault that is determined in operation 302 and the association relationship between an NSI and an NSSI, an NSSI having a potential fault in one or more NSSIs corresponding to the NSI having a potential fault.

In one embodiment, the fault information determined by the NSSMF in operation 301 includes a faulty NSI. Because the NSSMF can invoke the association relationship between an NSI and an NSSI, in operation 302, for the faulty NSI, the NSSMF may search for the association relationship between an NSI and an NSSI based on an identifier of the faulty NSI, and determine an NSSI having a potential fault in one or more NSSIs corresponding to the identifier of the faulty NSI, where the determined NSSI having a potential fault may be used as the potential fault information.

Then a fault detection mechanism of the NSSMF in the second application scenario is described. In the second application scenario, an association relationship that can be invoked when the potential fault information is detected includes the association relationship between an NSSI and an NF.

If the fault information determined by the NSSMF in operation 301 includes a faulty NF, because the NSSMF can invoke the association relationship between an NSSI and an NF, in operation 302, for the faulty NF, the NSSMF may search for the association relationship between an NSSI and an NF based on an identifier of the faulty NF, and determine an NSSI having a potential fault in one or more NSSIs corresponding to the identifier of the faulty NF. When the NSSMF determines the faulty NSSI, all NSSIs corresponding to the identifier of the faulty NF may be determined as NSSIs having a potential fault, or some NSSIs corresponding to the identifier of the faulty NF may be determined as NSSIs having a potential fault. A specific determining manner is not limited in this embodiment of this application.

In one embodiment, if the association relationship that can be invoked by the NSSMF may further include the association relationship between an NSI and an NSSI, the NSSMF may further determine, based on an identifier of the NSSI having a potential fault and the association relationship between an NSI and an NSSI, an NSI having a potential fault in one or more NSIs corresponding to the NSSI having a potential fault.

Then a fault detection mechanism of the NSSMF in the third application scenario is described. In the third application scenario, an association relationship that can be invoked when the potential fault information is detected includes the association relationship between an NSI and an NSSI and the association relationship between an NSSI and an NF.

If the fault information determined by the NSSMF in operation 301 includes a faulty NSSI, because the NSSMF can invoke the association relationship between an NSI and an NSSI, in operation 302, for the faulty NSSI in the fault information, the NSSMF may search for the association relationship between an NSI and an NSSI based on an identifier of the faulty NSSI, and determine an NSI having a potential fault in one or more NSIs corresponding to the identifier of the faulty NSSI.

In one embodiment, if the fault information determined by the NSSMF in operation 301 includes a faulty NF, in operation 302, the NSSMF may further search for the association relationship between an NSSI and an NF based on an identifier of the faulty NSI, and determine an NSSI having a potential fault in one or more services corresponding to the identifier of the faulty NF.

In one embodiment, if the association relationship that can be invoked by the NSSMF may further include the association relationship between an NSI and an NSSI, the NSSMF may further determine, based on an identifier of the NSSI having a potential fault and the association relationship between an NSI and an NSSI, an NSI having a potential fault in one or more NSIs corresponding to the NSSI having a potential fault.

According to the descriptions of the fault detection mechanisms of the NSSMF in the foregoing three application scenarios, the NSSMF determines the potential fault information by searching for the association relationship between an NSI and an NSSI and/or the association relationship between an NSSI and an NF, so that a possibility that the NSSMF can detect a potential fault in advance can be increased.

The first management unit may further process the determined potential fault information, to avoid impact, on service continuity provided by the slice network, caused by an actual fault in the NSI having a potential fault and/or the NSSI having a potential fault.

Therefore, after the fault detection mechanisms in different scenarios in which the NSSMF is used as the first management unit are described, the following describes how the first management unit processes the determined potential fault information.

After the first management unit determines the potential fault information, that is, after operation 302, the first management unit may further perform warning for the potential fault information to avoid a potential fault.

In one embodiment, the first management unit sends a warning message, where the warning message includes the potential fault information. In this processing manner, the first management unit may notify another processing device of a potential fault in the slice network by using the warning message, so that the another processing device processes the potential fault in the slice network. A receiver of the warning message may be a CSMF or an NSMF.

In one embodiment, the warning message may further include the fault information determined by the first management unit in operation 301, so that a receiver, such as the CSMF, that receives the warning message may learn of the potential fault in the slice network by using the warning message, and also learn of a fault that has occurred in the slice network, to facilitate subsequent unified processing.

The following describes, with reference to the accompanying drawings and some specific scenarios, the fault management method provided in the embodiments of this application.

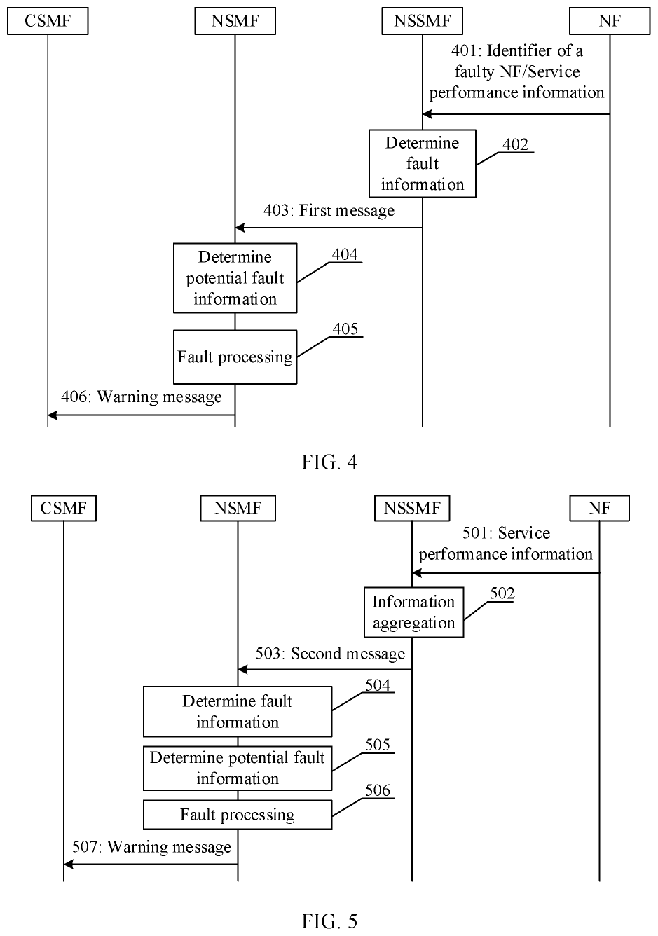

FIG. 4 is a signaling flowchart of a fault management method according to an embodiment of this application. As shown in FIG. 4:

401. The NF reports an identifier of a faulty NF or service performance information to the NSSMF.

For this operation, refer to the related implementation described when the first management unit is the NSSMF. It should be noted that when reporting the identifier of the faulty NF to the NSSMF, the NF may further report an identifier of a faulty service, a fault type, and the like.

402. The NSSMF determines fault information based on the identifier of the faulty NF or the service performance information, where the fault information may include a faulty NSSI and/or the faulty NF; and searches for an association relationship between an NSI and an NSSI, to determine a faulty NSI; or the NSSMF may determine an NSI having a potential fault.

403. The NSSMF sends a first message to an NSMF.

In this operation, if the NSSMF determines the faulty NSI, the first message may be the foregoing fault information. The first message may carry an identifier of the faulty NSI and an identifier of the faulty NSSI, and further carry the identifier of the faulty service, the fault type, and the like.

If the NSSMF further determines the NSI having a potential fault, the first message may further carry an identifier of the NSI having a potential fault.

404. The NSMF searches for an association relationship between an NSI and a service based on the obtained first message, and determines a service having a potential fault in one or more services corresponding to the identifier of the faulty NSI.

405. The NSMF may perform fault processing, and migrate the service having a potential fault to another NSI or NSSI without a potential fault.

406. The NSMF may further send a warning message to a CSMF, to notify the CSMF of the service having a potential fault, and further notify the CSMF of the identifier of the faulty NSI, the identifier of the faulty NSSI, the identifier of the faulty service, the fault type, and the like.

FIG. 5 is a signaling flowchart of a fault management method according to an embodiment of this application. A difference between the scenario shown in FIG. 5 and the scenario shown in FIG. 4 mainly lies in the NSSMF. In FIG. 5, the NSSMF no longer determines a faulty NSSI and/or a faulty NF, and instead the NSMF determines the faulty NSSI and/or the faulty NF. As shown in FIG. 5:

501. The NF reports service performance information to the NSSMF. The service performance information may include an NF identifier, a service identifier, service performance on the NF, and the like.

502. The NSSMF aggregates the service performance information reported by the NF, to obtain a second message. The second message may include an NSSI identifier and performance information corresponding to the NSSI, and may further include the service identifier, the NF identifier, and the like.

503. The NSSMF sends the second message to an NSMF.

504. The NSMF determines a faulty NSI based on the second message.

505: The NSMF determines potential fault information.

The NSMF searches for an association relationship between an NSI and a service based on an identifier of the faulty NSI, and determines a service having a potential fault in one or more services corresponding to the identifier of the faulty NSI.

506. The NSMF may perform fault processing, and migrate the service having a potential fault to another NSI or NSSI without a potential fault.

507. The NSMF may further send a warning message to a CSMF, to notify the CSMF of the service having a potential fault, and further notify the CSMF of the identifier of the faulty NSI, an identifier of a faulty NSSI, an identifier of a faulty service, a fault type, and the like.

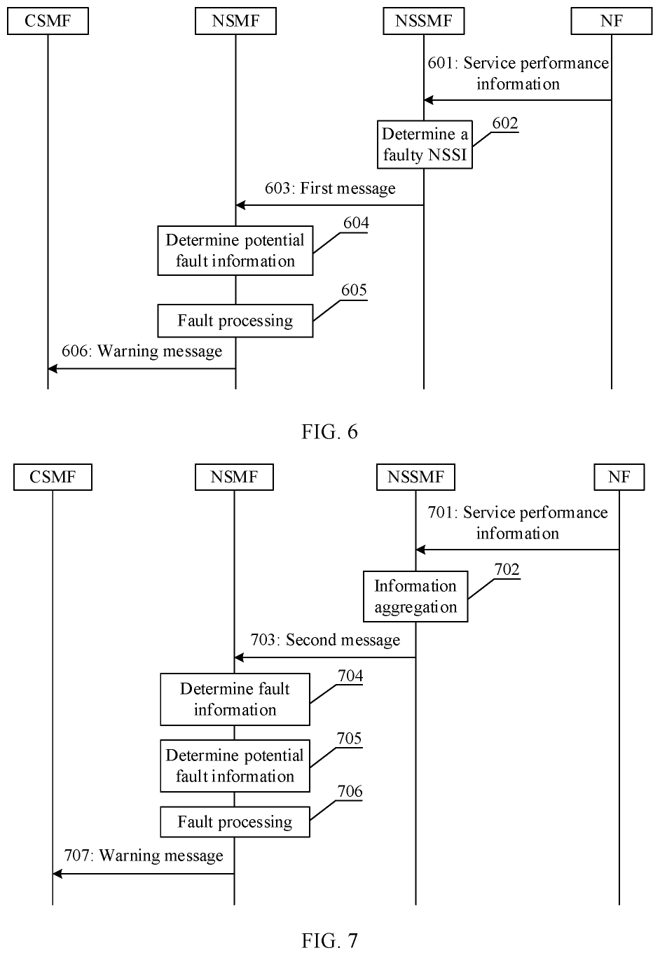

FIG. 6 is a signaling flowchart of a fault management method according to an embodiment of this application. A difference between the scenario shown in FIG. 6 and the scenarios shown in FIG. 4 and FIG. 5 mainly lies in the NSMF and the NSSMF. In FIG. 6, an association relationship that can be found by the NSMF may include an association relationship between an NSI and a service and an association relationship between an NSI and an NSSI. The NSSMF does not search for the association relationship. Therefore, in the scenario shown in FIG. 6, the NSMF is mainly used to determine the potential fault information. As shown in FIG. 6:

601. The NF reports service performance information to the NSSMF.

For this operation, refer to the content described when the first management unit is the NSSMF. The service performance information may further include an NF identifier and a service identifier.

602. The NSSMF may determine a faulty NSSI based on the aggregated service performance information reported by the NF.

603. The NSSMF sends a first message to an NSMF.

In this operation, if the NSSMF determines a faulty NSI, the first message may carry an identifier of the faulty NSI, and further carry an identifier of a faulty service, a fault type, and the like.

604. The NSMF searches for, based on the obtained first message, an association relationship between an NSI and an NSSI and an association relationship between an NSI and a service; and determines an NSI having a potential fault in one or more NSIs corresponding to an identifier of the faulty NSSI, and a service having a potential fault in one or more services corresponding to an identifier of an NSI having a potential fault.

605. The NSMF may perform fault processing, and migrate the service having a potential fault to another NSI or NSSI without a potential fault.

606. The NSMF may further send a warning message to a CSMF, to notify the CSMF of the service having a potential fault, and further notify the CSMF of the identifier of the faulty NSI, the identifier of the faulty NSSI, the identifier of the faulty service, a fault type, and the like.

FIG. 7 is a signaling flowchart of a fault management method according to an embodiment of this application. A difference between the scenario shown in FIG. 7 and the scenario shown in FIG. 6 mainly lies in the NSSMF. In FIG. 7, the NSSMF no longer determines a faulty NSSI and/or a faulty NF, and instead the NSMF determines the faulty NSSI and/or the faulty NF. As shown in FIG. 7:

701. The NF reports service performance information to the NSSMF. The service performance information may include an NF identifier, a service identifier, service performance on the NF, and the like.

702. The NSSMF aggregates the service performance information reported by the NF, to obtain a second message. The second message includes an NSSI identifier and performance information corresponding to the NSSI, and may further include the service identifier.

703. The NSSMF sends the second message to an NSMF.

704. The NSMF determines a faulty NSI and/or a faulty NSSI based on the second message.

705. The NSMF determines potential fault information based on the faulty NSI and/or the faulty NSSI.

For the faulty NSI, the NSMF searches for an association relationship between an NSI and a service based on an identifier of the faulty NSI, and determines a service having a potential fault in one or more services corresponding to the identifier of the faulty NSI.

For the faulty NSSI, the NSMF searches for, based on an identifier of the faulty NSSI, an association relationship between an NSI and an NSSI and an association relationship between an NSI and a service; and determines an NSI having a potential fault in one or more NSIs corresponding to the identifier of the faulty NSSI, and a service having a potential fault in one or more services corresponding to an identifier of the NSI having a potential fault.

706. The NSMF may perform fault processing, and migrate the service having a potential fault to another NSI or NSSI without a potential fault.

707. The NSMF may further send a warning message to a CSMF, to notify the CSMF of the service having a potential fault, and further notify the CSMF of the identifier of the faulty NSI, the identifier of the faulty NSSI, an identifier of a faulty service, a fault type, and the like.

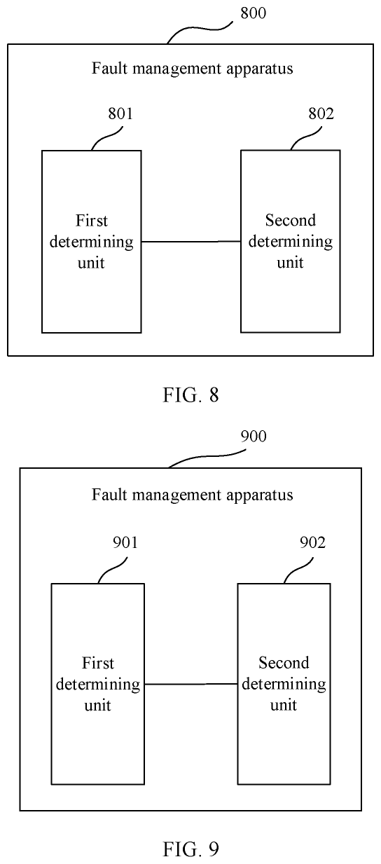

FIG. 8 is an apparatus structural diagram of a fault management apparatus according to an embodiment of this application. The fault management apparatus is applied to a slice network, and the fault management apparatus 800 includes a first determining unit 801 and a second determining unit 802.

The first determining unit 801 is configured to determine fault information, where the fault information includes a faulty slice and/or a faulty service, and the faulty slice includes a faulty network slice instance NSI and/or a faulty network slice subnet instance NSSI in the slice network.

The second determining unit 802 is configured to determine potential fault information in the slice network based on the fault information and an association relationship, where the potential fault information includes an NSI having a potential fault, an NSSI having a potential fault, and/or a service having a potential fault; and the association relationship includes an association relationship between an NSI and an NSSI and/or an association relationship between an NSI and a service in the slice network.

In one embodiment, the first determining unit is further configured to receive a first message sent by a second management unit, where the first message includes one or a combination of an identifier of the faulty NSI, an identifier of the NSI having a potential fault, an identifier of the faulty NSSI, an identifier of a faulty network function NF, or an identifier of the faulty service; and

the first determining unit is further configured to determine the fault information based on the first message.

In one embodiment, the first determining unit is further configured to obtain a second message sent by a second management unit, where the second message includes one or a combination of performance information of the NSSI, an NSSI identifier, an NF identifier, and a service identifier that are managed by the second management unit; and

the first determining unit is further configured to determine the fault information based on the second message.

In one embodiment, if the faulty slice includes the faulty NSI and the association relationship includes the association relationship between an NSI and a service, the second determining unit is further configured to determine, based on the identifier of the faulty NSI and the association relationship between an NSI and a service, the service having a potential fault in one or more services corresponding to the faulty NSI.

In one embodiment, if the first message includes the identifier of the NSI having a potential fault, the faulty slice includes the faulty NSI, and the association relationship includes the association relationship between an NSI and a service, the second determining unit is further configured to determine, based on the association relationship between an NSI and a service, the service having a potential fault in services corresponding to the identifier of the faulty NSI and the identifier of the NSI having a potential fault.

In one embodiment, if the faulty slice includes the faulty NSSI, and the association relationship includes the association relationship between an NSI and an NSSI and the association relationship between an NSI and a service, the second determining unit is further configured to determine, based on the identifier of the faulty NSSI and the association relationship between an NSI and an NSSI, the NSI having a potential fault in one or more NSIs corresponding to the faulty NSSI; and

the second determining unit is further configured to determine, based on the identifier of the NSI having a potential fault and the association relationship between an NSI and a service, the service having a potential fault in one or more services corresponding to the NSI having a potential fault.

In one embodiment, the association relationship includes the association relationship between an NSI and a service, and the second determining unit is further configured to determine, based on the identifier of the faulty service and the association relationship between an NSI and a service, the NSI having a potential fault in one or more services corresponding to the faulty NSI.

In one embodiment, the apparatus further includes a sending unit, where

the sending unit is configured to send a warning message, where the warning message includes the potential fault information.

In one embodiment, the apparatus further includes a processing unit, where

the processing unit is configured to perform fault processing based on the potential fault information, where

if the potential fault information includes the NSI having a potential fault and/or the NSSI having a potential fault, the fault processing includes reconfiguring the NSI having a potential fault and/or the NSSI having a potential fault; or if the potential fault information includes the service having a potential fault, the fault processing includes migrating the service having a potential fault to an NSI without a potential fault.

It can be learned that, in the slice network, if the fault management apparatus determines the fault information in the slice network, for example, the faulty slice and/or the faulty service, the fault management apparatus may determine, based on the fault information and an association relationship between slices, the potential fault information that may exist in the slice network, for example, the NSI, the NSSI, and/or the service that may have a potential fault. Because the association relationship between an NSI and an NSSI and the association relationship between an NSI and a service that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the service having a potential fault, to avoid interruption of a group call service caused by the actual fault, thereby improving service continuity provided by the slice network, and improving experience of a tenant in use of the slice network.

The fault management apparatus includes a processor and a memory. The first determining unit, the second determining unit, and the like are all stored in the memory as program units, and the processor executes the program units stored in the memory to implement corresponding functions.

The processor includes a kernel, and the kernel invokes a corresponding program unit from the memory. One or more kernels may be set, and fault management in the slice network is performed by adjusting a kernel parameter.

The memory may include a non-persistent memory, a random access memory (RAM), and/or a non-volatile memory in a computer-readable medium, for example, a read-only memory (ROM) or a flash memory (flash RAM). The memory includes at least one storage chip.

An embodiment of this application provides a device. The device includes a processor, a memory, and a program that is stored in the memory and that can run on the processor. When executing the program, the processor implements the following operations: determining fault information, where the fault information includes a faulty slice and/or a faulty service, and the faulty slice includes a faulty network slice instance NSI and/or a faulty network slice subnet instance NSSI a the slice network; and determining potential fault information in the slice network based on the fault information and an association relationship, where the potential fault information includes an NSI having a potential fault, an NSSI having a potential fault, and/or a service having a potential fault; and the association relationship includes an association relationship between an NSI and an NSSI and/or an association relationship between an NSI and a service in the slice network. The device in this embodiment may be a server, a PC, a PAD, a mobile phone, or the like.

FIG. 9 is an apparatus structural diagram of a fault management apparatus according to an embodiment of this application. The fault management apparatus is applied to a slice network, and the fault management apparatus 900 includes a first determining unit 901 and a second determining unit 902.

The first determining unit 901 is configured to determine fault information, where the fault information includes a faulty network slice instance NSI, a faulty network slice subnet instance NSSI, and/or a faulty network function NF in the slice network.

The second determining unit 902 is configured to determine potential fault information in the slice network based on the fault information and an association relationship, where the potential fault information includes an NSI having a potential fault, an NSSI having a potential fault, and/or an NF having a potential fault; and the association relationship includes an association relationship between an NSI and an NSSI and/or an association relationship between an NSSI and an NF in the slice network.

In one embodiment, the first determining unit is further configured to obtain an identifier of the faulty NF sent by a network unit, and

the first determining unit is further configured to determine the corresponding faulty NF based on the identifier of the faulty NF.

In one embodiment, the first determining unit is further configured to obtain service performance information sent by a network unit, where the service performance information is used to reflect NF performance; and

the first determining unit is further configured to identify the faulty NSSI and/or the faulty NF based on the service performance information.

In one embodiment, the first determining unit is further configured to obtain an identifier of the faulty NSI sent by a second management unit, and

the first determining unit is further configured to determine the corresponding faulty NSI based on the identifier of the faulty NSI.

In one embodiment, if the fault information includes the faulty NSI and the association relationship includes the association relationship between an NSI and an NSSI, the second determining unit is further configured to determine, based on the identifier of the faulty NSI and the association relationship between an NSI and an NSSI, the NSSI having a potential fault in one or more NSSIs corresponding to the faulty NSI.

In one embodiment, if the fault information includes the faulty NSSI and the association relationship includes the association relationship between an NSI and an NSSI, the second determining unit is further configured to determine, based on the identifier of the faulty NSSI and the association relationship between an NSI and an NSSI, the NSI having a potential fault in one or more NSIs corresponding to the faulty NSSI.

In one embodiment, if the fault information includes the faulty NSSI and the association relationship includes the association relationship between an NSSI and an NF, the second determining unit is further configured to determine, based on the identifier of the faulty NSSI and the association relationship between an NSSI and an NF, the NF having a potential fault in one or more NFs corresponding to the faulty NSSI.

It can be learned that, in the slice network, if the fault management apparatus determines the fault information in the slice network, the fault management apparatus may determine, based on the fault information and an association relationship between slices, the potential fault information that may exist in the slice network, for example, the NSI, the NSSI, and/or the NF that may have a potential fault. Because the association relationship between an NSI and an NSSI and the association relationship between an NSSI and an NF that are included in the slice network can reflect a network topology relationship between parts in the slice network, the potential fault information determined based on the association relationship can reflect impact of a fault on the slice network by using the network topology relationship. The potential fault information is detected in advance, so that corresponding processing can be performed before an actual fault occurs in the NSI having a potential fault, the NSSI having a potential fault, and/or the NF having a potential fault, to avoid interruption of a group call service caused by the actual fault, thereby improving service continuity provided by the slice network, and improving experience of a tenant in use of the slice network.

The fault management apparatus includes a processor and a memory. The first determining unit, the second determining unit, and the like are all stored in the memory as program units, and the processor executes the program units stored in the memory to implement corresponding functions.

The processor includes a kernel, and the kernel invokes a corresponding program unit from the memory. One or more kernels may be set, and fault management in the slice network is performed by adjusting a kernel parameter.

The memory may include a non-persistent memory, a random access memory (RAM), and/or a non-volatile memory in a computer-readable medium, for example, a read-only memory (ROM) or a flash memory (flash RAM). The memory includes at least one storage chip.

An embodiment of this application provides a device. The device includes a processor, a memory, and a program that is stored in the memory and that can run on the processor. When executing the program, the processor implements the following operations: determining fault information, where the fault information includes a faulty network slice instance NSI, a faulty network slice subnet instance NSSI, and/or a faulty network function NF in a slice network; and determining potential fault information in the slice network based on the fault information and an association relationship, where the potential fault information includes an NSI having a potential fault, an NSSI having a potential fault, and/or an NF having a potential fault; and the association relationship includes an association relationship between an NSI and an NSSI and/or an association relationship between an NSSI and an NF in the slice network. The device in this embodiment may be a server, a PC, a PAD, a mobile phone, or the like.

It may be clearly understood by persons skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software function unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the operations of the methods in the embodiments of this application. The storage medium includes any medium that can store program code, such as a USB flash drive, a removable hard disk, a read-only memory (ROM), a random access memory (RAM), a magnetic disk, or an optical disc.

The foregoing embodiments are merely intended to describe the technical solutions of this application, but are not to limit this application. Although this application is described in detail with reference to the foregoing embodiments, persons of ordinary skill in the art should understand that they may still make modifications to the technical solutions described in the foregoing embodiments or make equivalent replacements to some technical features thereof. However, these modifications or replacements do not make the essence of the corresponding technical solutions depart from the spirit and scope of the technical solutions of the embodiments of this application.

1. A fault management method applied to a slice network, the method comprising:
determining, by a first management unit, fault information comprising a faulty slice and/or a faulty service, and wherein the faulty slice comprises a faulty network slice instance (NSI) and/or a faulty network slice subnet instance (NSSI) in the slice network; and
determining, by the first management unit, potential fault information in the slice network based on the fault information and an association relationship, wherein the potential fault information comprises an NSI having a potential fault, an NSSI having a potential fault, and/or a service having a potential fault; and wherein the association relationship comprises an association relationship between an NSI and an NSSI and/or an association relationship between an NSI and a service in the slice network.

2. The method according to claim 1, wherein the determining, by the first management unit, the fault information comprises:
receiving, by the first management unit, a first message sent by a second management unit, wherein the first message comprises one or more of an identifier of the faulty NSI, an identifier of the NSI having a potential fault, an identifier of the faulty NSSI, an identifier of a faulty network function (NF), or an identifier of the faulty service; and
determining, by the first management unit, the fault information based on the first message.

3. The method according to claim 1, wherein the determining, by the first management unit, the fault information comprises:
obtaining, by the first management unit, a second message sent by a second management unit, wherein the second message comprises one or more of performance information of the NSSI, an NSSI identifier, an NF identifier, and a service identifier that are managed by the second management unit; and
determining, by the first management unit, the fault information based on the second message.

4. The method according to claim 1, wherein if the faulty slice comprises the faulty NSI and the association relationship comprises the association relationship between the NSI and the service, the determining, by the first management unit, the potential fault information in the slice network based on the fault information and the association relationship comprises:
determining, by the first management unit based on the identifier of the faulty NSI and the association relationship between the NSI and the service, the service having the potential fault in one or more services corresponding to the faulty NSI.

5. The method according to claim 2, wherein if the first message comprises the identifier of the NSI having the potential fault, the faulty slice comprises the faulty NSI, and the association relationship comprises the association relationship between the NSI and the service, the determining, by the first management unit, the potential fault information in the slice network based on the fault information and the association relationship comprises:
determining, by the first management unit based on the association relationship between the NSI and the service, the service having the potential fault in services corresponding to the identifier of the faulty NSI and the identifier of the NSI having the potential fault.

6. The method according to claim 1, wherein if the faulty slice comprises the faulty NSSI, and the association relationship comprises the association relationship between the NSI and the NSSI and the association relationship between the NSI and the service, the determining, by the first management unit, the potential fault information in the slice network based on the fault information and the association relationship comprises:
determining, by the first management unit based on the identifier of the faulty NSSI and the association relationship between the NSI and the NSSI, the NSI having the potential fault in one or more NSIs corresponding to the faulty NSSI; and
determining, by the first management unit based on the identifier of the NSI having potential fault and the association relationship between the NSI and the service, the service having the potential fault in one or more services corresponding to the NSI having the potential fault.

7. The method according to claim 1, wherein the association relationship comprises the association relationship between an NSI and a service, the determining, by the first management unit, potential fault information in the slice network based on the fault information and an association relationship comprises:
determining, by the first management unit based on the identifier of the faulty service and the association relationship between the NSI and the service, the NSI having the potential fault in one or more services corresponding to the faulty NSI.

8. The method according to claim 1, wherein after the determining, by the first management unit, the potential fault information in the slice network based on the fault information and the association relationship, the method further comprises:
sending, by the first management unit, a warning message, wherein the warning message comprises the potential fault information.

9. The method according to claim 1, wherein after the determining, by the first management unit, the potential fault information in the slice network based on the fault information and the association relationship, the method further comprises:
performing, by the first management unit, a fault processing based on the potential fault information, wherein
if the potential fault information comprises the NSI having the potential fault and/or the NSSI having the potential fault, the fault processing comprises reconfiguring the NSI having the potential fault and/or the NSSI having the potential fault; or if the potential fault information comprises the service having the potential fault, the fault processing comprises migrating the service having the potential fault to an NSI without a potential fault.

10. A fault management apparatus, comprising:
a processor and a memory unit storing program codes, which when executed by the processor, cause the apparatus to:
determine fault information comprising a faulty slice and/or a faulty service, and the faulty slice comprises a faulty network slice instance (NSI) and/or a faulty network slice subnet instance (NSSI) in a slice network; and
determine potential fault information in the slice network based on the fault information and an association relationship, wherein the potential fault information comprises an NSI having a potential fault, an NSSI having a potential fault, and/or a service having a potential fault; and the association relationship comprises an association relationship between an NSI and an NSSI and/or an association relationship between an NSI and a service in the slice network.

11. The apparatus according to claim 10, wherein the program codes further cause the apparatus to receive a first message sent by a second management unit, wherein the first message comprises one or more of an identifier of the faulty NSI, an identifier of the NSI having a potential fault, an identifier of the faulty NSSI, an identifier of a faulty network function (NF), or an identifier of the faulty service; and to determine the fault information based on the first message.

12. The apparatus according to claim 10, wherein the program codes further cause the apparatus to obtain a second message from a second management unit, wherein the second message comprises one or more of performance information of the NSSI, an NSSI identifier, an NF identifier, and a service identifier that are managed by the second management unit; and to determine the fault information based on the second message.

13. The apparatus according to claim 10, wherein the faulty slice comprises the faulty NSI and the association relationship comprises the association relationship between the NSI and the service, the program codes cause the apparatus to determine, based on the identifier of the faulty NSI and the association relationship between the NSI and the service, the service having the potential fault in one or more services corresponding to the faulty NSI.

14. The apparatus according to claim 11, wherein the first message comprises the identifier of the NSI having tea potential fault, the faulty slice comprises the faulty NSI, and the association relationship comprises the association relationship between the NSI and the service, the program codes cause the apparatus to determine, based on the association relationship between the NSI and the service, the service having the potential fault in services corresponding to the identifier of the faulty NSI and the identifier of the NSI having the potential fault.

15. The apparatus according to claim 10, wherein the faulty slice comprises the faulty NSSI, and the association relationship comprises the association relationship between the NSI and the NSSI and the association relationship between the NSI and the service, the program codes cause the apparatus to determine, based on the identifier of the faulty NSSI and the association relationship between the NSI and the NSSI, the NSI having the potential fault in one or more NSIs corresponding to the faulty NSSI; and to determine, based on the identifier of the NSI having the potential fault and the association relationship between the NSI and the service, the service having the potential fault in one or more services corresponding to the NSI having the potential fault.

16. The apparatus according to claim 10, wherein the association relationship comprises the association relationship between the NSI and the service, and the program codes cause the apparatus to determine, based on the identifier of the faulty service and the association relationship between the NSI and the service, the NSI having the potential fault in one or more services corresponding to the faulty NSI.

17. The apparatus according to claim 10, wherein the program codes cause the apparatus to perform a fault processing based on the potential fault information, wherein
if the potential fault information comprises the NSI having the potential fault and/or the NSSI having the potential fault, the fault processing comprises reconfiguring the NSI having the potential fault and/or the NSSI having the potential fault; or if the potential fault information comprises the service having the potential fault, the fault processing comprises migrating the service having the potential fault to an NSI without a potential fault.

18. A fault management method applied to a slice network, the method comprising:
determining, by a first management unit, fault information comprising a faulty network slice instance (NSI), a faulty network slice subnet instance (NSSI), and/or a faulty network function (NF) in the slice network; and
determining, by the first management unit, potential fault information in the slice network based on the fault information and an association relationship, wherein the potential fault information comprises an NSI having a potential fault, an NSSI having a potential fault, and/or an NF having a potential fault; and the association relationship comprises an association relationship between an NSI and an NSSI and/or an association relationship between an NSSI and an NF in the slice network.

19. The method according to claim 18, wherein if the fault information comprises the faulty NSI and the association relationship comprises the association relationship between an NSI and an NSSI, the determining, by the first management unit, the potential fault information in the slice network based on the fault information and the association relationship comprises:
determining, by the first management unit based on the identifier of the faulty NSI and the association relationship between the NSI and the NSSI, the NSSI having the potential fault in one or more NSSIs corresponding to the faulty NSI.

20. The method according to claim 18, wherein if the fault information comprises the faulty NSSI and the association relationship comprises the association relationship between the NSI and the NSSI, the determining, by the first management unit, the potential fault information in the slice network based on the fault information and the association relationship comprises:
determining, by the first management unit based on the identifier of the faulty NSSI and the association relationship between the NSI and the NSSI, the NSI having the potential fault in one or more NSIs corresponding to the faulty NSSI.
